(19) United States
(12) Patent Application Publication
(10) Pub. No.: US 2023/0126786 A1
(43) Pub. Date: Apr. 27, 2023

(54) Plant-Based Cheese Product And Method Of Making A Plant-Based Cheese Product

(71) Applicant: Kraft Foods Group Brands LLC, Chicago, IL (US)

(72) Inventors: Tracy Joella Sanborn, Glen Ellyn, IL (US); Mary C. Doyle, Chicago, IL (US); Lacey Ann Thomas, Frankfort, IL (US); Alexis Marie Fye, Hawthorn Woods, IL (US); Samy Darwan, Chicago, IL (US); Andrew Edward McPherson, Mount Prospect, IL (US)

(21) Appl. No.: 18/087,552

(22) Filed: Dec. 22, 2022

Related U.S. Application Data
(63) Continuation-in-part of application No. PCT/US2022/027051, filed on Apr. 29, 2022.
(60) Provisional application No. 63/427,589, filed on Nov. 23, 2022.
(60) Provisional application No. 63/191,795, filed on May 21, 2021.

(51) Int. Cl. A23C 20/02; A23L 29/212; A23L 29/256

(52) U.S. Cl. CPC A23C 20/025; A23L 29/212; A23L 29/256

(57) ABSTRACT

A plant-based cheese product is provided. The plant-based cheese products have an appearance, cold texture, and melting characteristics similar to a dairy-based cheese. The cheese products include a plant-based protein, at least a first starch and a second starch, a fat component, and an acidulant. The first starch comprises a hydrophobic starch. The second starch comprises a modified starch. The fat component has a solid fat content in the range of 30% to about 60% at 50° F. and 0% to about 10% at 92° F. A flexibility enhancing agent may also be included.

### CROSS-REFERENCE TO RELATED APPLICATIONS

This application claims the benefit of U.S. Provisional Application No. 63/427,589, filed Nov. 23, 2022, and is also a continuation-in-part of International Application No. PCT/US2022/027051, filed Apr. 29, 2022, which claims the benefit of U.S. Provisional Application No. 63/191,795, filed May 21, 2021.

### FIELD

This application relates generally to plant-based cheese products.

### BACKGROUND

Some commercially available plant-based cheese products have been able to replicate the color and texture of dairy-based cheese products at refrigerated temperatures. However, these typical plant-based cheese products often do not have other functional characteristics expected of dairy-based cheeses, including melting characteristics at cooking temperatures. Indeed, some plant-based cheese products do not melt uniformly at high temperatures, such as when making foods like a grilled cheese or pizza. For example, currently available plant-based cheese products in shredded form often retain their shredded appearance even after being exposed to cooking temperatures. These plant-based cheese products are not as well accepted by consumers who expect a cooking and eating experience that replicates dairy-based cheeses.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a graph showing the elastic modulus values for Samples 1-12 of Example 1.

FIG. 2 is a graph showing the complex viscosity values for Samples 1-12 of Example 1.

FIG. 3 is a graph showing the softening behavior from 0-80° C. for Samples 1-12 of Example 1.

FIG. 4 is a graph showing the destabilization kinetics of Samples 1-12 of Example 1.

FIG. 5 is a graph showing the fat droplet size distribution (frequency) of Samples 1-12 of Example 1.

FIG. 6 is a graph showing the fat droplet size distribution (cumulative) of Samples 1-12 of Example 1.

FIG. 7 is a graph showing the water droplet size distribution (frequency) of Samples 1-12 of Example 1.

FIG. 8 is a graph showing the water droplet size distribution (cumulative) of Samples 1-12 of Example 1.

FIG. 9 is a photograph of a grilled cheese type product with an example plant-based cheese product melted therein; and

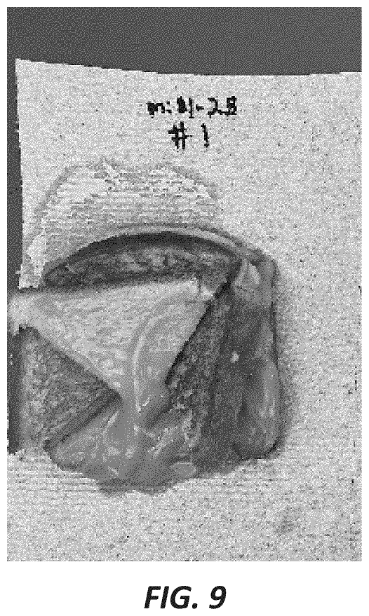

FIG. 10 is a photograph of another grilled cheese type product with another example plant-based cheese product melted therein.

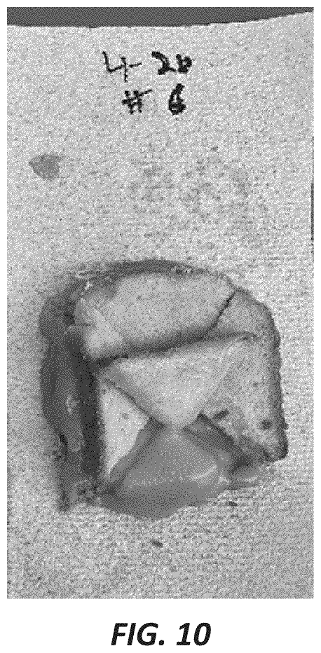

The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are plant-based cheese products. For purposes herein, the term “plant-based cheese product” refers to cheese analogues or cheese alternatives prepared with proteins of non-dairy origin. The plant-based cheese products have an appearance, cold texture, and melting characteristics similar to a dairy-based cheese. The dairy proteins in dairy-based cheese create a network and structure that results in the cold texture and hot/melt texture of the dairy-based cheese. Casein is the dairy protein that contributes substantial functionality to dairy-based cheeses. Plant-based proteins generally have different functionality, and plant-based cheese products need to balance the differing functionality with other ingredients to provide a product having desirable properties at both cold and hot temperatures. As the plant-based cheese product disclosed herein may be free of dairy proteins, dairy proteins cannot be relied upon to produce the desired cold texture and melting characteristics, including meltability at conventional cooking temperatures and texture upon melting. Rather, it has been unexpectedly found that a plant-based cheese product with characteristics consistent with consumer expectations for a dairy-based cheese could be obtained through use of a combination of a plant-based protein, fat component, hydrophobic starch, and a modified starch. In some embodiments, a plant-based cheese product with characteristics consistent with consumer expectations for a dairy-based cheese could be obtained through use of a combination of a plant-based protein, fat component, hydrophobic starch, a modified starch, and a flexibility enhancing agent.

In one approach, the plant-based cheese product includes: a plant-based protein; at least a first and second starch, the first starch comprising a hydrophobic starch and the second starch comprising a modified starch; a flexibility enhancing agent; a fat component having a solid fat content in the range of 30% to about 60% at 50° F. and about 0% to about 10% at 92° F.; and an acidulant in an amount effective to provide a pH of the plant-based cheese product of about 4.5 to about 5.7.

In another approach, the plant-based-cheese product may include two modified starches, including a water-managing starch and a gelling starch, in addition to the hydrophobic starch. In one aspect, the plant-based protein is chickpea protein, which provides hot viscosity and emulsification. The combination of starches provides a significant amount of emulsification, hot viscosity, and cold texture. The resulting plant-based cheese product is sliceable at cold temperatures and also has desirable melt characteristics at cooking temperatures.

The plant-based cheese product disclosed herein may formed into desirable shape. In some examples, the plant-based cheese product is in the form of a cheese block, a sliced cheese, a diced cheese, or a shredded cheese. In some approaches, the plant-based cheese product may be in the form of an oil-in-water emulsion. In some approaches, the plant-based cheese product may be in the form of an oil-in-water emulsion that is solidified in the form of a cheese block, a sliced cheese, a diced cheese, or a shredded cheese at a temperature of 5° C.

The plant-based cheese product includes a plant-based protein. For sake of simplicity and purposes herein, the term “plant-based protein” includes any non-dairy and non-animal-based proteins. The term “plant-based protein” also specifically encompasses fungus-based proteins or proteins produced via fermentation by microbes, even though those proteins are not of plant origin.

Any suitable plant-based protein may be used in the plant-based cheese product. In some embodiments, the plant-based protein comprises one or more of chickpea protein, fava protein, soy protein, mung bean protein, pea protein, canola protein, and lentil protein. In some approaches, the plant-based protein can be in the form of an isolate, a concentrate, or a flour, though the precise form of the plant-based protein is not believed to be particularly limited. In one embodiment, the plant-based protein comprises chickpea protein. In some examples, the fungus protein comprises mycoprotein.

As noted above, the plant-based protein may also be of microbial origin. For example, proteins commonly of dairy-based origin, such as casein or whey, may be obtained via microbial fermentation. If produced by a microorganism using a non-dairy based substrate and fermentation medium, the resulting protein would be considered a plant-based protein for purposes herein.

In some embodiments, the plant-based protein is the only source of protein in the plant-based cheese product. In this respect, in some embodiments, the plant-based cheese product includes no animal proteins, including, for example, casein and whey. Additionally, or alternatively, the product may be a vegan cheese product (i.e., there are no ingredients of animal origin of any kind in the cheese product).

In one approach, the plant-based protein is present in an amount within the range of about 1 wt % to about 25 wt % crude protein, based on a total weight of the plant-based cheese product. In another approach, the plant-based protein is present in an amount within the range of about 2 wt % to about 20 wt % crude protein, about 2 wt % to about 15 wt % crude protein, about 4 wt % to about 15 wt % crude protein, or about 4 wt % to about 10 wt % crude protein based on a total weight of the plant-based cheese product. In one approach, the plant-based protein may be included in an amount of 2 wt % to less than 6 wt % crude protein, 2.5 wt % to 5.5 wt % crude protein, or 3 wt % to 5 wt % crude protein based on a total weight of the plant-based cheese product. Other types of plant-based cheese products may have a higher amount of plant-based protein, such as 6 wt % crude protein or more, 6 wt % to 10 wt % crude protein, 6.5 wt % to 9.5 wt % crude protein, or 7 wt % to 9 wt % crude protein based on a total weight of the plant-based cheese product.

The amount of crude protein in a plant-based protein ingredient may depend on the form of the ingredient (e.g., whether the ingredient is in the form of an isolate, a concentrate, or a flour). Therefore, for purposes herein, plant-based protein refers to the crude protein content, i.e., the amount of protein contributed by the ingredient that delivers the plant-based protein. For instance, the commercially available ARTESA® chickpea protein product includes about 60% protein and 40% non-protein components. If a plant-based cheese product includes about 13 wt % ARTESA® chickpea protein product, the plant-based cheese product will include about 8 wt % plant-based protein, for percentage purposes herein. The amount of crude protein in a plant-based protein ingredient or in the plant-based cheese product may be measured by the Association of Official Analytical Chemists (AOAC) Official Method 992.15 (which is incorporated herein by reference in its entirety). Additionally, or alternatively, the amount of crude protein in a plant-based protein ingredient or in the plant-based cheese product may be measured by the Dumas Method.

In some approaches, it has been found to be advantageous that the plant-based protein have a small mean particle size to allow for good dispersion of the protein within the fat component. For example, use of a plant-based protein having a mean particle size below about 15 microns may be beneficial. In another aspect, use of a plant-based protein having a mean particle size in the range of about 6 to about 15 microns, in another aspect about 8 to about 11 microns, may be beneficial. In some examples, the mean particle size of the protein may be determined using dynamic light scattering. As an example, a Zetasizer Ultra-DLS (Malvern) may be used to measure the mean particle size using dynamic light scattering.

In some approaches, the inclusion of chickpea protein, and with the small mean particle size described herein, has surprisingly been found to provide significant benefits to the “oiling off” problem that can occur with dairy-based cheese products when not stored at refrigerated temperatures. Oiling off refers to the separation of oil from the other ingredients, resulting in a product that exudes oil during production, at room temperature, or when heated.

The plant-based cheese products further include a combination of at least two starches to achieve the desired characteristics. The plant-based cheese product includes at least a first starch and a second starch. As mentioned above, the combination of the first starch and the second starch can provide the plant-based cheese product the desired cold texture and hot/melt texture.

In one aspect, the first starch is a hydrophobic starch. The hydrophobic starch may act as an emulsifier during the manufacturing process and in the plant-based cheese product. The hydrophobic starch may also provide water management to the plant-based cheese product.

Any suitable hydrophobic starch may be used. In some examples, the hydrophobic starch may be an octenyl succinic anhydride (OSA) starch. Examples of suitable hydrophobic starches include, for example, ACCUBIND® starch (Cargill) or STA-MIST® starch (Tate & Lyle), which are both OSA-modified dent corn starches. It is presently believed that the hydrophobic starch acts as an emulsifier.

In one approach, the hydrophobic starch is present in an amount within the range of about 0.5 wt % to about 15 wt %, about 1 wt % to about 13 wt %, in another aspect about 5 wt % to about 15 wt %, about 7 wt % to about 13 wt %, about 8 wt % to about 11 wt %, or about 8 wt % to about 10 wt %, based on a total weight of the plant-based cheese product.

The second starch is a modified starch different from the first, hydrophobic starch. In one approach, any suitable modified waxy starch may be used. In some examples, the modified waxy starch may be a waxy (non-amylose containing starch) starch that is crosslinked, substituted, or both crosslinked and substituted. The modified waxy starch is selected to provide viscosity and water management when the cheese product is at elevated temperature, either during the manufacturing process or upon heating by the consumer. The modified waxy starch may be referred to as a water-managing starch. For instance, the modified starch may be REZISTA® starch (Tate & Lyle) and/or SHUR-FIL® 677 modified starch (Tate & Lyle). The SHUR-FIL® 677 modified starch can provide thickening effect at elevated temperatures, such as between 100 to 150° F.

In another approach, the modified starch may further comprise a modified starch such as a dent corn starch that forms a thermoreversible gel. This additional starch may also be selected from hydrolyzed, amylose-containing starches. In one exemplary approach, the starch may be an acid-thinned starch. The additional starch may be a gelling starch. For instance, the acid-thinned or gelling starch may be THINGUM® starch (Tate & Lyle). The hydrolyzed, amylose-containing starch is selected to provide firmness upon cooling, a low hot viscosity, and sliceability to the plant-based cheese product.

At least in some embodiments, it has been found advantageous that a combination of modified starches be included (i.e., both a modified waxy starch (water-managing starch) and a hydrolyzed, amylose-containing starch (gelling starch)) along with the first hydrophobic starch. The relative amounts of the modified starches are selected to provide the desired properties in the cheese product. The combination of second starches can provide desirable physical properties at both hot and cold temperatures (such as firmness upon cooling and desirable viscosity at elevated temperatures), thereby better replicating the properties of dairy-based cheeses and meeting consumer expectations.

In one approach, the second starch, which may include a combination of modified starches, is present in an amount within the range of about 0.5 to about 15 wt %, about 1.5 wt % to about 14 wt %, about 2 wt % to about 12 wt %, about 2 wt % to about 10 wt %, based on a total weight of the plant-based cheese product. The ranges here are applicable to modified waxy starch and hydrolyzed amylose-containing starch included individually, or to a combination of modified waxy starch and hydrolyzed amylose-containing starch.

In one approach, the water-managing starch is present in an amount within the range of about 1 to about 12 wt %, about 1.5 wt % to about 10 wt %, or about 2 wt % to about 9 wt %, based on a total weight of the plant-based cheese product. The ranges here are applicable to one or more modified waxy starches. For plant-based cheese products having an amount of protein from 2 wt % to less than 6 wt % crude protein, the water-managing starch may be included in an amount such as about 4 to about 12 wt %, about 4 wt % to about 10 wt %, or about 5 wt % to about 9 wt %, based on a total weight of the plant-based cheese product. For plant-based cheese products having a higher amount of protein, such as 6% or more crude protein, generally less water-managing starch may be included, such as about 1 to about 8 wt %, about 1.5 wt % to about 6 wt %, or about 2 wt % to about 5 wt %, based on a total weight of the plant-based cheese product.

In one approach, the gelling starch is present in an amount within the range of about 0.25 wt % to about 4 wt %, about 0.5 wt % to about 3 wt %, about 0.5 wt % to about 2 wt %, or about 0.75 wt % to about 1.5 wt %, based on a total weight of the plant-based cheese product. The ranges here are applicable to one or more modified waxy starches.

In one approach, the modified waxy starch and hydrolyzed amylose-containing starches may be included in a ratio of about 10:1 to about 1:10, and in another aspect about 5:1 to about 1:5, and in another aspect about 3:1 to about 1:3.

Water is also included in an amount of about 30 wt % to about 60 wt %, in another aspect about 37 wt % to about 55 wt %, in another aspect about 42 wt % to about 55 wt %, based on a total weight of the plant-based cheese product.

The plant-based cheese product may further include a flexibility enhancing agent, which results in decreased friability and/or rigidity of the cheese product. For example, the flexibility enhancing agent may act as a filler. Additionally, or alternatively, the flexibility enhancing agent may contribute to flexibility of the plant-based cheese product. The flexibility enhancing agent may be a polysaccharide, gum, or hydrocolloid. Suitable flexibility enhancing agents include, for example, one or more of instant starch, xanthan gum, guar gum, locust bean gum, cellulose gum, fenugreek gum, konjac gum, agar, gellan gum, propylene glycol alginate (PGA), alginate, microcrystalline cellulose (MCC), carboxymethyl cellulose (CMC), konjac glucomannan, carrageenan, and pectin. In some examples, the flexibility enhancing agent comprises one or more of carrageenan and pectin. It has been found that addition of a polysaccharide, gum, or hydrocolloid can further improve sliceability of the plant-based cheese product at cold temperatures (e.g., 5° C.).

In one approach, the flexibility enhancing agent is present in an amount within the range of about 0.05 wt % to about 5 wt %, in another aspect about 0.05 wt % to about 4 wt %, in another aspect about 0.05 to about 3 wt %, in another aspect about 0.05 wt % to about 2 wt %, in another aspect about 0.05 wt % to about 1 wt %, in another aspect about 0.05 wt % to about 0.5 wt %, and in another aspect about 0.1 wt % to about 0.3 wt %. In one particular approach, the flexibility enhancing agent is a hydrocolloid, such as carrageenan.

In another approach, the flexibility enhancing agent may include about 0.1 wt % to about 20 wt %, based on a total weight of the plant-based cheese product. In another approach, the flexibility enhancing agent is present in an amount within the range of about 0.1 to about 15 wt %, about 0.1 to about 12 wt %, about 0.2 to about 12 wt %, about 1 wt % to about 15 wt %, about 1 wt % to about 12 wt %, about 2 wt % to about 10 wt %, about 2 wt % to about 5 wt %, or about 5 wt % to about 10 wt %, based on a total weight of the plant-based cheese product.

The plant-based cheese product further includes a fat component having a solid fat content in the range of about 30% to about 60% at 50° F. and 0% to about 10% at 92° F. When the fat component has a solid fat content within the specified ranges, the fat component may act similarly to butter fat, which may contribute to the plant-based cheese product having a flavor profile, cold texture, and melt profile similar to a dairy-based cheese.

Any suitable fat component comprising one or more solid fats, liquid oils, or combination thereof having a solid fat content in the range of about 30% to about 60% at 50° F. and 0% to about 10% at 92° F. may be used. In some examples, the fat component comprises one or more of coconut oil, palm oil, palm oil fraction, shea butter, and shea olein. In some of these examples, the fat component further comprises one or more of soybean oil, sunflower oil, olive oil, canola oil, peanut oil, sesame oil, and corn oil to provide a blend of ingredients to provide the desired solid fat content at the respective temperatures. In other examples, the fat component comprises the coconut oil.

In one approach, the fat component is present in an amount within the range of about 15 to about 30 wt %, in another aspect about 20 wt % to about 30 wt %, based on a total weight of the plant-based cheese product.

The plant-based cheese product further includes an acidulant in an amount effective to provide a pH of the plant-based cheese product of about 4.5 to about 5.7, in another aspect about 4.8 to about 5.7, in another aspect about 4.8 to about 5.5, in another aspect about 4.8 to about 5.0, in another aspect about 5.0 to about 5.7, and in another aspect about 5.2 to about 5.5. Any suitable acidulant may be used. In one example, the acidulant comprises one or more of citric, acetic, phosphoric, sorbic, and lactic acid.

In general, the cold and hot melt characteristics and texture of the plant-based cheese product can be manipulated by adjusting the relative amounts of the hydrophobic and modified starches, as well as the amounts of total starch relative to the protein content of the plant-based cheese product. Further, additional starches may be included, if desired. Generally, as the amount of protein in the plant-based cheese is decreased, additional starch is needed to provide the desired texture and functionality.

Textural attributes can be measured through rheological thermal analysis test. In the tests, viscoelastic properties are measured as a function of temperature, when a sample of cheese slice is subjected to an oscillating strain at a frequency of 10 rad/s while continuously heated at 5° C/min the temperature range of 0-80° C. The material response (stress) to applied sinusoidal strain is measured and the viscoelastic properties are calculated from the stress strain data. TA Instruments ARES-G2 rheometer can be used for the tests. All the following viscoelastic properties can be calculated from the stress-strain response of the same experiment.

Using a TA Instrument ARES-G2 Rheometer, a sinusoidal shear strain is applied to a 2 mm thick, 25 mm diameter disc of each plant-based cheese sample while heating the sample at a rate of 5° C/minute from 0° C. to 80° C., and the resulting stress wave is measured. The test geometry is a 25 mm cross hatched parallel plate with a 500 mm cross hatched bottom peltier plate. The geometry gap is equal to the sample thickness (i.e., 2 mm). The samples are loaded at 30° C. The axial force is 10 g±5 g, and the sampling rate was 12 s/point.

The complex viscosity, elastic modulus, loss modulus, and Tan 6 (i.e., the quotient of the loss modulus (G″) and the elastic modulus (G′) (i.e., G″/G′)), as a function of temperature of each of the samples, can be calculated from the stress-strain curves. The tests are repeated until two overlaying curves of elastic modulus vs. temperature are obtained.

Tan Delta is the ratio of viscous modulus to the elastic modulus and is a measure of the strength of intermolecular bonds in the cheese matrix. The strength of intermolecular bonds or relaxation time is inversely proportional to tan delta values.

The melting point is the temperature at which tan delta value becomes equal to unity. At the melting point or when tan delta value becomes equal to 1, the material loses its elasticity and starts to flow.

The firmness of the plant-based cheese products is equal to elastic modulus (G′). It is the material's ability to store (as elasticity) part of applied energy during deformation. This energy can be recovered after removal of stress or strain. The elastic modulus is a measure of firmness of the cheese and proportional to the density of intermolecular bonds in the cheese matrix.

Complex Viscosity

In any of these embodiments, the complex viscosity may be measured after heating a mixture (or second mixture) or combination of the ingredients of the plant-based cheese product to a temperature of about 80° C. For example, the complex viscosity of an oil-in-water emulsion product can be measured using a DHR rheometer with parallel plate attachments (25 mm cross hatched parallel top plate with 60 mm cross hatched bottom plate and 1 mm gap between plates) over a ramping temperature range of 5-80° C. Specifically, temperature is increased at 2° C/min, the applied stress is 10 Pa, and the frequency is 10 rad/s. The processing conditions greatly impact the resulting product viscosity as smaller emulsion droplets will produce significantly more viscous product, which is, accordingly, more stable to creaming forces.

In one approach, the combination of starches (and optionally flexibility enhancing agent) are present in an amount effective to provide a plant-based cheese product having a complex viscosity at a frequency of 10 rad/s and a temperature of 5° C. within the range of about 30,000 Pa·s to about 200,000 Pa·s, in another aspect about 30,000 to about 160,000 Pa·s, and in another aspect about 40,000 to about 160,000 Pa·s.

In one approach, the combination of starches (and optionally flexibility enhancing agent) are present in an amount effective to provide a plant-based cheese product having a complex viscosity at a frequency of 10 rad/s and a temperature of 25° C. within the range of about 100 Pa·s to about 1500 Pa·s, in another aspect about 400 to about 1000 Pa·s, in another aspect about 400 to about 1000 Pa·s, in another aspect about 500 to about 1000 Pa·s, in another aspect about 600 to about 1000 Pa·s, in another aspect about 700 to about 1000 Pa·s, and in another aspect about 700 to about 900 Pa·s.

In one approach, the combination of starches (and optionally flexibility enhancing agent) are present in an amount effective to provide a plant-based cheese product having a complex viscosity at a frequency of 10 rad/s and a temperature of 37° C. within the range of about 100 Pa·s to about 100 Pa·s, in another aspect about 200 to about 800 Pa·s, in another aspect about 300 to about 700 Pa·s, and in another aspect about 400 to about 600 Pa·s.

In one approach, the combination of starches (and optionally flexibility enhancing agent) are present in an amount effective to provide a plant-based cheese product having a complex viscosity at a frequency of 10 rad/s and a temperature of 80° C. within the range of about 1 Pa·s to about 200 Pa·s, in another aspect about 1 to about 50 Pa·s, in another aspect about 1 to about 25 Pa·s, and in another aspect about 5 to about 20 Pa·s.

Elastic Modulus

In another approach, the combination of starches (and optionally flexibility enhancing agent) are present in an amount effective to provide a plant-based cheese product having an elastic modulus at 5° C. of about 300,000 Pa to about 2,000,000 Pa, in another aspect about 300,000 Pa to about 1,500,000 Pa, and in another aspect about 400,000 Pa to about 1,400,000 Pa.

At least in some approaches, for plant-based cheese products having a crude protein content of 2 wt % to less than 6 wt %, it has been found to be desirable to have an elastic modulus of less than about 1,000,000 Pa because of possible brittleness. In one aspect, it may be desirable for the plant-based cheese product to have an elastic modulus at 5° C. of about 200,000 Pa to about 800,000 Pa, in another aspect about 300,000 Pa to about 700,000 Pa, and in another aspect about 400,000 Pa to about 700,000 Pa when the plant-based cheese product has a crude protein content of 2 wt % to less than 6 wt %.

Similarly, it is presently thought that plant-based cheese products having a higher crude protein content (6 wt % or more) can tolerate higher elastic modulus values at 5° C. without the cheese having a brittle texture. Accordingly, in one aspect, it may be desirable for the plant-based cheese product to have an elastic modulus at 5° C. of about 700,000 Pa to about 1,500,000 Pa, in another aspect about 800,000 Pa to about 1,500,000 Pa, and in another aspect about 900,000 Pa to about 1,400,000 Pa when the plant-based cheese product has a crude protein content of 6 wt % or more, or 6 wt % to 10 wt %.

In another approach, the combination of starches (and optionally flexibility enhancing agent) are present in an amount effective to provide a plant-based cheese product having an elastic modulus at 25° C. of about 1,000 Pa to about 15,000, in another aspect about 3,000 Pa to about 12,000 Pa, in another aspect about 5,000 Pa to about 10,000 Pa, and in another aspect about 7,500 Pa to about 10,000 Pa.

In another approach, the combination of starches (and optionally flexibility enhancing agent) are present in an amount effective to provide a plant-based cheese product having an elastic modulus at 37° C. of about 1,000 Pa to about 10,000, in another aspect about 3,000 Pa to about 10,000 Pa, in another aspect about 4,000 Pa to about 10,000 Pa, and in another aspect about 5,000 Pa to about 8,000 Pa.

In another approach, the combination of starches (and optionally flexibility enhancing agent) are present in an amount effective to provide a plant-based cheese product having an elastic modulus at 80° C. of about 50 Pa to about 500 Pa, in another aspect about 75 Pa to about 300 Pa, and in another aspect about 100 Pa to about 250 Pa.

Viscous Modulus

In another approach, the combination of starches (and optionally flexibility enhancing agent) are present in an amount effective to provide a plant-based cheese product having a viscous modulus at 5° C. of about 100,000 Pa to about 1,000,000, in another aspect about 150,000 Pa to about 750,000, and in another aspect about 200,000 Pa to about 600,000.

In another approach, the combination of starches (and optionally flexibility enhancing agent) are present in an amount effective to provide a plant-based cheese product having a viscous modulus at 25° C. of about 1000 Pa or more, in another aspect about 2000 Pa or more, and in another aspect about 3500 Pa or more.

In another approach, the combination of starches (and optionally flexibility enhancing agent) are present in an amount effective to provide a plant-based cheese product having a viscous modulus at 37° C. of about 1000 Pa or more, in another aspect about 2000 Pa or more, and in another aspect about 3500 Pa or more.

In another approach, the combination of starches (and optionally flexibility enhancing agent) are present in an amount effective to provide a plant-based cheese product having a viscous modulus at 80° C. of 20 Pa or more.

Softening

In another approach, the combination of starches (and optionally flexibility enhancing agent) are present in an amount effective to provide a plant-based cheese product having a temperature at 80% softening of at least 15° C., at least 16° C., at least 17° C., or at least 18° C. The temperature at which the material loses 80% of firmness is considered the softening point. At the softening point, the elastic modulus will be equal to 20% of the elastic modulus at 0° C.

Emulsion Stability

In yet another approach, the combination of starches (and optionally flexibility enhancing agent) are present in an amount effective to provide a plant-based cheese product having a Turbiscan measure of less than 10 at 60° C. The stability of the emulsions can be evaluated using a Turbiscan (Technex B.V., Netherlands). In the Turbiscan, any physical changes occurring in a sample matrix is tracked by changes in magnitude of light transmission and scattering throughout the length of the sample vial. The changes in transmission increases with increasing separation of oil or water from the matrix. The changes in scattering intensity increases with the coagulation or coalescence in the matrix. The calculated stability index is the cumulative changes in magnitude of the light transmission and scattering, integrated over the length of the tube. A stability index of zero indicates that the sample is stable with no changes in physical status with reference initial state. A more stable matrix will have low stability index when compared to the sample with higher stability index.

Fat Droplet Size

In some examples, the fat droplet size distribution may be measured by a Bruker time-domain nuclear magnetic resonance (TD-NMR). In one aspect, the plant-based cheese mixture may be mixed or homogenized to achieve a D50 (i.e., 50% of the fat droplets diameters are below this value) at 40° C. of 40 μm or less, in another aspect 30 μm or less, in another aspect 20 μm or less. In another aspect, the mixture may be homogenized to achieve a D50 at 40° C. within the range of about 1 μm to about 40 μm, in another aspect within the range of about 1 μm to about 30 μm, or in another aspect within the range of about 1 μm to about 20 μm.

Additionally to the D50 values, or alternatively, the plant-based cheese product may have a width of distribution (i.e., the standard deviation (D97.5−D2.5/4)), wherein 97.5% of the fat droplet diameters are below the D97.5 and 2.5% of the fat droplet diameters are below the D2.5 value) at 40° C. of 75 μm or less, in another aspect 50 μm or less, in another aspect 40 μm or less, in another aspect 30 μm or less, in another aspect 25 μm or less, and in another aspect 20 μm or less. (i.e., 97.5% of the fat droplets diameters are below this value) at 40° C. of 200 μm or less, in another aspect 175 μm or less, in another aspect 150 μm or less, in another aspect 100 μm or less. In another aspect, the mixture may be homogenized to achieve a D97.5 at 40° C. within the range of about 1 μm to about 200 μm, in another aspect within the range of about 10 μm to about 175 μm, in another aspect within the range of about 20 μm to about 150 μm, or in another aspect within the range of about 20 μm to about 100 μm.

Additionally, or alternatively, the mixture may be homogenized to achieve a D2.5 (i.e., 2.5% of the fat droplets diameters are below this value) at 40° C. of 10 μm or less, 5 μm or less, or 3 μm or less. In another aspect, the mixture may be homogenized to achieve a D2.5 at 40° C. within the range of about 0.1 μm to about 10 μm, in another aspect within the range of about 0.5 μm to about 5 μm, or in another aspect within the range of about 0.5 μm to about 3 μm.

For instance, the plant-based cheese products described herein have acceptable meltability at cooking temperatures, firm texture at refrigeration temperature, and suitable overall mouthfeel similar to dairy-based cheese products. The plant-based cheese products maintain physical integrity at refrigeration temperatures but also melt when exposed to elevated temperatures.

Antimicrobial agents may also be added to the plant-based cheese products in order to enhance resistance to bacterial and mold growth, such as by addition of sorbic acid, cultured vinegar, cultured sugar, cultured dextrose. In some approaches, the antimicrobial agent may also be serving as an acidulant.

The plant-based cheese product may be provided in a variety of flavors, such as American, Swiss, gouda, provolone, cheddar, Colby, Colby-jack, pepper-jack, or mozzarella. Flavoring agents may be added to achieve the desired flavor profile. Colors may also be added to achieve the desired color to the plant-based cheese product.

In another approach, inclusions may be added to achieve the desired flavor profile. For example, herbs, spices, peppers, chilies, garlic, natural or artificial flavors, and the like, alone or in combination, may be added to provide a desired flavor profile.

In addition to the hydrophobic starch, a chemical emulsifier may be included. Suitable chemical emulsifiers include, for example as orthophosphates (including disodium phosphates, monosodium phosphates, and trisodium phosphates), sodium hexametaphosphates, sodium acid pyrophosphates, trisodium citrate, polyoxyethylene sorbitan monostearate (polysorbate 60), or other emulsifiers or combinations of emulsifiers. In other approaches, no chemical emulsifiers are included.

In some examples, the plant-based cheese product may additionally include a flavor masking agent. Masking agents may include any suitable ingredient effective to lower a perceived intensity of a particular flavor. In some applications, consumers may perceive non-dairy proteins as contributing an off-flavor to a cheese-type product (i.e., a flavor inconsistent with consumer expectations for a dairy-based cheese). For example, soy is sometimes perceived as contributing an undesirable beany flavor to food products. To reduce the flavor of certain non-dairy proteins, it may be desirable to include a flavor masking agent. For example, agents may include sweeteners (including nutritive and non-nutritive sweeteners), flavors, bitter blockers, or other suitable additive. Any suitable amount may be included. In one particular approach, the agent may be effective to bind to the off-flavors, thereby reducing or preventing the perception of the flavor. Suitable flavor binders include, for example, thaumatin and neohesperidin dihydrochalcone (NHDC), which may also be categorized as sweeteners, and generally are included in an amount within the range of greater than 0 wt % to about 0.005 wt %, based on a total weight of the plant-based cheese product.

The plant-based cheese products described herein can be made by a variety of methods. In one approach, the plant-based cheese products can be made by the method comprising combining a fat component with water, a plant-based protein, and at least two starches, wherein the first starch is a hydrophobic starch, and the second starch is a modified starch. The fat component has a solid fat content in the range of about 30% to about 60% at 50° F. and 0% to about 10% at 92° F. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. The ingredients may be blended while heating, if desired. Further, the ingredients may be held at the increased temperature for a time effective to pasteurize the mixture, such as with continued mixing. The mixture may be heated via steam injection or other means.

In another approach, the fat component may be melted, such as in a cooker, before the other ingredients are added, as described above.

In another approach, the plant-based cheese products can be made by the method comprising melting a fat component, adding at least two starches to the melted fat, wherein the first starch is a hydrophobic starch, and the second starch is a modified starch, and mixing the at least two starches and melted fat component to thoroughly distribute the at least two starches into the melted fat to provide a homogenous first mixture. In some approaches, the modified starch may comprise one or both of a modified waxy starch and a gelling starch. The fat component has a solid fat content in the range of about 30% to about 60% at 50° F. and 0% to about 10% at 92° F. Additional ingredients can then be added, including water, acidulant, plant-based protein, and flexibility enhancing agent. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. The ingredients may be blended while heating, if desired. Further, the ingredients may be held at the increased temperature for a time effective to pasteurize the mixture, such as with continued mixing.

In another approach, the plant-based cheese products can be made by the method comprising melting a fat component, adding a plant-based protein, a flexibility enhancing agent, and water to the melted fat component to provide a first mixture. The fat component has a solid fat content in the range of about 30% to about 60% at 50° F. and 0% to about 10% at 92° F. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. At least a first starch and a second starch are combined with water and then added to the heated mixture, wherein the first starch is a hydrophobic starch, and the second starch is a modified starch, to provide a second mixture. In some approaches, the modified starch may comprise one or both of a modified waxy starch and a gelling starch. The second mixture is then held at the heated temperature for at the increased temperature for a time effective to pasteurize the mixture, such as with continued mixing if desired.

In one particular approach, the method comprises melting a fat component having a solid fat content in the range of about 30% to about 60% at 50° F. and 0% to about 10% at 92° F.; adding water to the melted fat source to form a first mixture; adding a plant-based protein, a hydrophobic starch, and a modified starch to the first mixture and mixing to form a second mixture; heating the second mixture to a temperature within the range of about 170° F. to about 200° F.; holding the mixture at the heating temperature for at heating time period within the range of about 30 seconds to about 90 seconds to form a heated mixture; and cooling the heated mixture to form the plant-based cheese product.

In another approach, the plant-based cheese products can be made by the method comprising: melting a fat source having a solid fat content in the range of about 30% to about 60% at 50° F. and 0% to about 10% at 92° F.; adding a modified starch and a hydrophobic starch to the melted fat source to form a first mixture; adding water, a flexibility enhancing agent ,and plant-based protein to the first mixture and mixing to form a second mixture; heating the second mixture to a temperature within the range of about 170° F. to about 200° F.; holding the mixture at the heating temperature for a heating time period within the range of about 30 seconds to about 90 seconds to form a heated mixture; and cooling the heated mixture to form the plant-based cheese product.

In one aspect, when mixing the plant-based protein, hydrophobic starch, and a modified starch with the melted fat, it may be desirable to mix the ingredients at a speed of at least about 500 rpm, in another aspect about 500 rpm to about 2500 rpm, and for a mixing time period within the range of about 2 minutes to about 15 minutes to provide a homogeneous, pasteurized mixture.

In another aspect, any of the methods described herein may further comprise filling the heated mixture into one or more containers prior to the cooling step. In another aspect, the cooling step may be accomplished on a chill belt.

In another aspect, any of the methods described herein may further comprise adding an acidulant to the first or second mixture. In one approach, the acidulant is added in an amount effective to provide a pH in the range of about 4.4 to about 5.7, in another aspect a pH of about 4.7 to about 5.5, in another aspect about 4.8 to about 5.3, and in another aspect about 4.8 to about 5.0, in the final plant-based cheese product. The acidulant may be any food grade acidulant, such as citric acid, lactic acid, or combination thereof. In one aspect, the acidulant is lactic acid, which can provide a characteristic dairy flavor to the plant-based cheese product. The inclusion of the acidulant to a provide a pH in the described ranges contributes to microbial stability of the product as well as providing desirable flavor.

In another aspect, any of the methods described herein may further comprise combining the plant-based protein with a flavor masking agent and water prior to combining the plant-based protein with other ingredients of the plant-based cheese product.

In another aspect, any of the methods described herein may further comprise adding one or more of salt, a preservative, colorant, and flavor. Particulates or inclusions (e.g., herbs, spices, pepper pieces) may also be added with any of the methods described herein.

The methods described herein may also further comprise cutting the plant-based cheese product into various shapes and sizes, such as blocks, slices, cubes, shreds, and the like.

Cheeses may be cooked and processed using any conventional equipment, including the use of a laydown cooker, kettle, or other device. Shredding and packaging may also be accomplished with conventional equipment.

To further illustrate the present disclosure, examples are given herein. It is to be understood that these examples are provided for illustrative purposes and are not to be construed as limiting the scope of the present disclosure.

### EXAMPLES

### Example 1

Plant-based cheese products were prepared to evaluate the effect of three types of starches on the properties of the cheeses at temperatures relevant to sliced cheese products, including sliceability at cold temperatures, product handling by the consumer at 25° C. or 37° C., and melting characteristics at cooking temperatures (e.g., 80° C.). Samples were prepared according to the twelve formulations below in Tables 1-3.

Samples 1-8 included chickpea protein as the plant-based protein, with samples 5-8 including twice the amount of chickpea protein as samples 1-4. Samples 9-12 included faba protein as the plant-based protein. Because of the additional solids in the form of chickpea protein in samples 5-8, additional maltodextrin was used in samples 1-4 and 5-8.

Samples 1, 5, and 9 included a combination of all three groups of starches (hydrophobic starch, water-managing starch, and gelling starch).

Samples 2, 6, and 10 lacked the gelling starch (THINGUM® starch). Samples 3, 7, and 11 lacked the water-managing starches (REZISTA® starch and SHUR-FIL®). Samples 4, 8, and 12 lacked a hydrophobic starch (ACCUBIND®). Maltodextrin was included in place of the starches.

Each of the example plant-based cheese products were prepared by first melting coconut oil in a cooker. Water was added to the melted coconut oil, and then lactic acid was added in an amount effective to provide a pH within the range of about 4.8 to about 5.0 in the final product. Chickpea or faba protein, maltodextrin, salt, sorbic acid, REZISTA® starch (Tate & Lyle) if applicable, Shur-FIL® starch (Tate & Lyle) if applicable, THINGUM® starch (Tate & Lyle) if applicable, and ACCUBIND® starch (Cargill) if applicable, were added, and the ingredients were then mixed and heated (via steam injection) in a steam injection cooker (Stephan Machinery GmbH) at shear rate and for a time period sufficient to produce a homogenous mixture. Once the mixture was well mixed, it was further heated (via steam injection) to 185° F. and held at 185° F. for 1 minute to pasteurize the mixture. Then, the heated mixture was filled into a box and allowed to cool to form a block of the plant-based cheese product.

TABLE 1

| | | | Sample 3 | Sample 4 |
|---|---|---|---|---|
| | Sample 1 | Sample 2 | (Chickpea, | (Chickpea, |
| | (Chickpea, | (Chickpea, | no water- | no |
| | all | no gelling | managing | hydrophobic |
| | starches) | starch) | starch) | starch) |
| Coconut oil | 24.25% | 24.25% | 24.25% | 24.25% |
| ACCUBIND ® | 9.00% | 9.00% | 9.00% | 0.00% |
| 12675 | | | | |
| Water | 43.909% | 43.909% | 43.909% | 43.909% |
| Lactic acid | 0.10% | 0.10% | 0.10% | 0.10% |
| Artesa Chickpea | 6.67% | 6.67% | 6.67% | 6.67% |
| Protein (60% | | | | |
| crude protein) | | | | |
| STAR-DRI ® | 6.42% | 7.42% | 13.12% | 15.42% |
| 100 maltodextrin | | | | |
| (Tate & Lyle) | | | | |
| THINGUM ® | 1.00% | 0.00% | 1.00% | 1.00% |
| 107A starch | | | | |
| ShurFIL ® 677 | 3.70% | 3.70% | 0.00% | 3.70% |
| starch | | | | |
| REZISTA ® | 3.00% | 3.00% | 0.00% | 3.00% |
| starch | | | | |
| Sodium chloride | 1.77% | 1.77% | 1.77% | 1.77% |
| (salt) | | | | |
| Sorbic acid | 0.18% | 0.18% | 0.18% | 0.18% |
| Total | 100.000% | 100.000% | 100.000% | 100.000% |
| Crude protein % | 4.00% | 4.00% | 4.00% | 4.00% |
| (calculated) | | | | |
| Crude protein % | 3.77% | 3.62% | 3.79% | 3.76% |
| (measured) | | | | |
| pH | 5.0 | 5.0 | 5.0 | 5.0 |

TABLE 2

| | | | Sample 7 | Sample 8 |
|---|---|---|---|---|
| | Sample 5 | Sample 6 | (2X | (2X |
| | (2X | (2X | Chickpea, | Chickpea, |
| | Chickpea, | Chickpea, | no water- | no |
| | all | no gelling | managing | hydrophobic |
| | starches) | starch) | starch) | starch) |
| Coconut oil | 23.77% | 23.77% | 23.77% | 23.77% |
| ACCUBIND ® | 9.00% | 9.00% | 9.00% | 0.00% |
| 12675 | | | | |
| Water | 44.460% | 44.460% | 44.460% | 44.460% |
| Lactic acid | 0.10% | 0.10% | 0.10% | 0.10% |
| Artesa Chickpea | 13.33% | 13.33% | 13.33% | 13.33% |
| Protein (60% | | | | |
| crude protein) | | | | |
| STAR-DRI ® | 3.55% | 4.55% | 6.39% | 12.55% |
| 100 maltodextrin | | | | |
| (Tate & Lyle) | | | | |
| THINGUM ® | 1.00% | 0.00% | 1.00% | 1.00% |
| 107A starch | | | | |
| ShurFIL ® 677 | 0.84% | 0.84% | 0.00% | 0.84% |
| starch | | | | |
| REZISTA ® | 2.00% | 2.00% | 0.00% | 2.00% |
| starch | | | | |
| Sodium chloride | 1.77% | 1.77% | 1.77% | 1.77% |
| (salt) | | | | |
| Sorbic acid | 0.18% | 0.18% | 0.18% | 0.18% |
| Total | 100.000% | 100.000% | 100.000% | 100.000% |
| Crude protein % | 8.00% | 8.00% | 8.00% | 8.00% |
| (calculated) | | | | |
| Crude protein % | 7.3% | 7.23% | 7.22% | 7.18% |
| (measured) | | | | |
| pH | 5.37 | 5.37 | 5.33 | 5.34 |

TABLE 3

| | | | Sample 11 | Sample 12 |
|---|---|---|---|---|
| | Sample 9 | Sample 10 | (Faba, | (Faba, |
| | (Faba, | (Faba, | no water- | no |
| | all | no gelling | managing | hydrophobic |
| | starches) | starch) | starch) | starch) |
| Coconut oil | 24.25% | 24.25% | 24.25% | 24.25% |
| ACCUBIND ® | 9.00% | 9.00% | 9.00% | 0.00% |
| 12675 | | | | |
| Water | 43.909% | 43.909% | 43.909% | 43.909% |
| Lactic acid | 0.10% | 0.10% | 0.10% | 0.10% |
| Faba* (60% | 6.67% | 6.67% | 6.67% | 6.67% |
| crude protein) | | | | |
| STAR-DRI ® | 6.42% | 7.42% | 13.12% | 15.42% |
| 100 maltodextrin | | | | |
| (Tate & Lyle) | | | | |
| THINGUM ® | 1.00% | 0.00% | 1.00% | 1.00% |
| 107A starch | | | | |
| ShurFIL ® 677 | 3.70% | 3.70% | 0.00% | 3.70% |
| starch | | | | |
| REZISTA ® | 3.00% | 3.00% | 0.00% | 3.00% |
| starch | | | | |
| Sodium chloride | 1.77% | 1.77% | 1.77% | 1.77% |
| (salt) | | | | |
| Sorbic acid | 0.18% | 0.18% | 0.18% | 0.18% |
| Total | 100.000% | 100.000% | 100.000% | 100.000% |
| Crude protein % | 4.00% | 4.00% | 4.00% | 4.00% |
| (calculated) | | | | |
| Crude protein % | 3.83% | 3.85% | 3.91% | 3.92% |
| (measured) | | | | |
| pH | 5.05 | 4.98 | 4.99 | 4.94 |

*Vitessence 3600 (Ingredion)

The cheese samples were then evaluated for a variety of properties, including cold firmness (texture), softening behavior, hot viscosity, fat and water droplet size, and emulsion stability.

Rheological Thermal Analysis

Rheological thermal analysis was performed on each of the samples using a TA Instruments ARES-G2 Rheometer. The rheological data indicated the relative firmness and textural attributes of the samples.

The viscoelastic properties of plant-based cheese slices are measured through rheological thermal analysis test. In the tests, viscoelastic properties are measured as a function of temperature, when a sample of cheese slice is subjected to an oscillating strain at a frequency of 10 rad/s while continuously heated at 5° C/min the temperature range of 0-80° C. The material response (stress) to applied sinusoidal strain is measured and the viscoelastic properties are calculated from the stress strain data. TA Instruments ARES-G2 rheometer was used for the tests. All the following viscoelastic properties are calculated from the stress-strain response of the same experiment.

Using the TA Instrument ARES-G2 Rheometer, a sinusoidal shear strain was applied to a 2 mm thick, 25 mm diameter disc of each plant-based cheese sample while heating the sample at a rate of 5° C/minute from 0° C. to 80° C., and the resulting stress wave was measured. The test geometry was a 25 mm cross hatched parallel plate with a 500 mm cross hatched bottom pettier plate. The geometry gap was equal to the sample thickness (i.e., 2 mm). The samples were loaded at 30° C. The axial force was 10 g±5 g, and the sampling rate was 12 s/point.

The complex viscosity, elastic modulus, loss modulus, and Tan 6 (i.e., the quotient of the loss modulus (G″) and the elastic modulus (G′) (i.e., G″/G′)) as a function of temperature of each of the samples, was calculated from the stress-strain curves. The tests were repeated until two overlaying curves of elastic modulus vs. temperature were obtained.

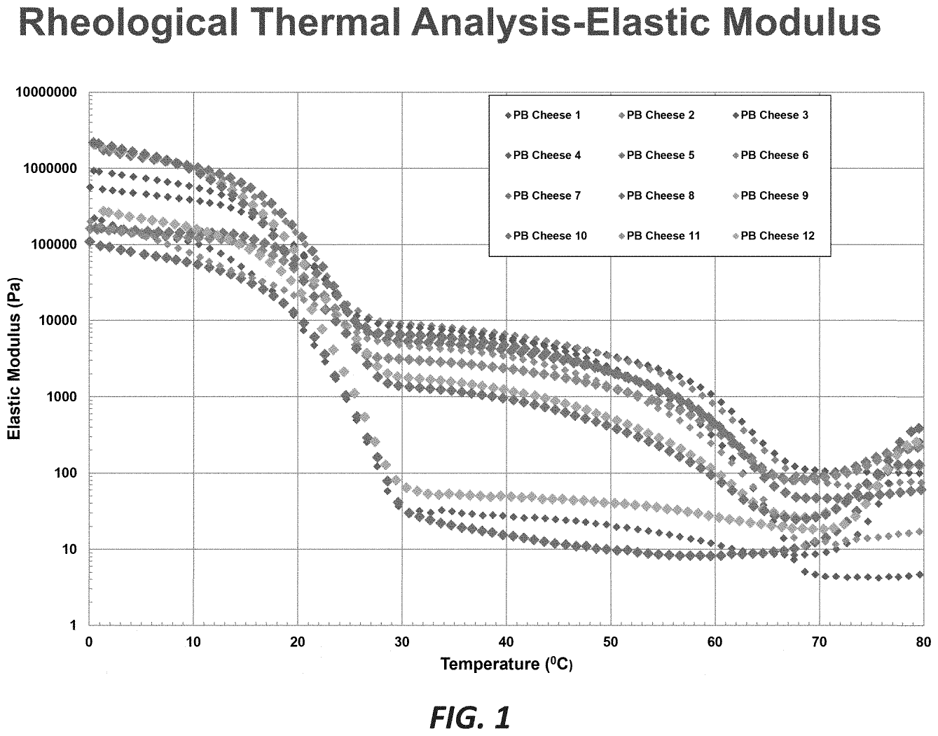

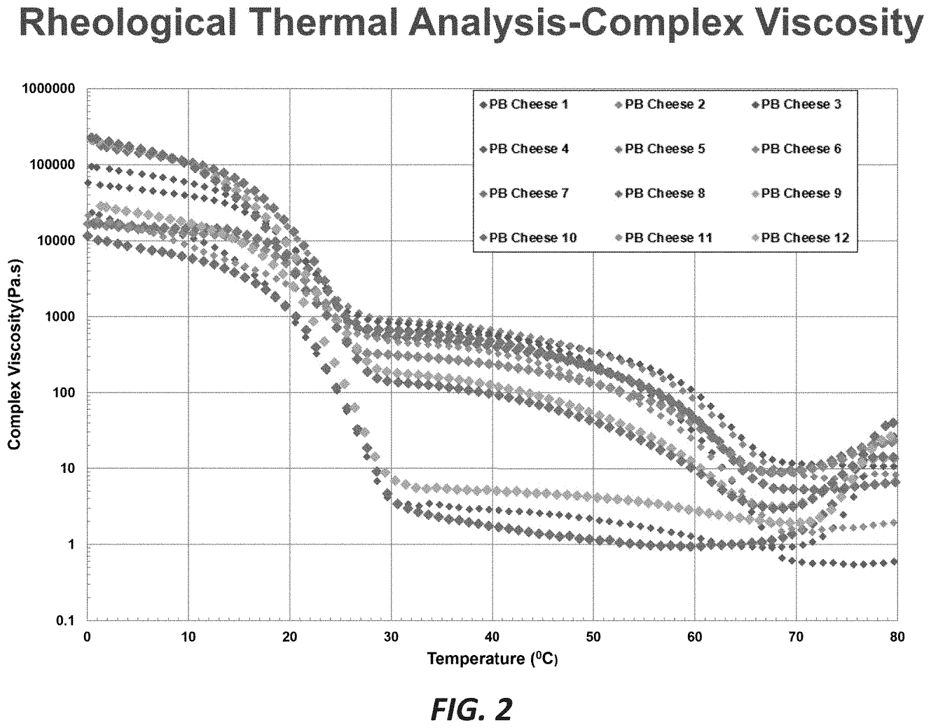

The elastic modulus (Pa) as a function of temperature (° C.) of each of the samples is shown in FIG. 1. The complex viscosity at a frequency of 10 rad/s (Pa·s) as a function of temperature (° C.) of each of the samples is shown in FIG. 2. The elastic modulus (Pa), loss modulus (Pa), Tan 6, and complex viscosity (Pa·s, at a frequency of 10 rad/s) data of each of the samples at a temperature of 5° C. (refrigerated temperature), 25° C. (room temperature), 37° C. (mouth temperature), and 80° C. (processing temperature) are presented in Tables 4 and 5 below.

Tan Delta: Tan Delta is the ratio of viscous modulus to the elastic modulus and is a measure of the strength of intermolecular bonds in the cheese matrix. The strength of intermolecular bonds or relaxation time is inversely proportional to tan delta values.

Melting point: The melting point is the temperature at which tan delta value becomes equal to unity. At the melting point or when tan delta value becomes equal to 1, the material loses its elasticity and starts to flow.

The results for the tests at 5° C. and 25° C. are presented in Table 4 below. The results for the tests at 37° C. and 80° C. are presented in Table 5 below.

TABLE 4

| | | | | | Properties at 25° C. | | | |
|---|---|---|---|---|---|---|---|---|
| | Properties at 5° C. | | | | | | | Complex |
| | | | | Complex | | | | viscosity |
| | Elastic | | Viscous | viscosity | Elastic | | Viscous | at 10 |
| | Modulus | Tan | Modulus | at 10 rad/s | Modulus | Tan | Modulus | rad/s |
| Sample | (Pa) | Delta | (Pa) | (Pa · s) | (Pa) | Delta | (Pa) | (Pa · s) |
| 1 | 458,370 | 0.489 | 224,040 | 46,786 | 8,684 | 0.476 | 4,132 | 887 |
| 2 | 1,465,460 | 0.435 | 637,470 | 150,368 | 13,362 | 0.489 | 6,528 | 1364 |
| 3 | 738,480 | 0.519 | 382,971 | 75,208 | 11,506 | 0.705 | 8,109 | 1162 |
| 4 | 131,228 | 0.254 | 33,385 | 14,100 | 495 | 0.177 | 88 | 57 |
| 5 | 1,313,825 | 0.421 | 553,348 | 135,035 | 8,098 | 0.489 | 3,963 | 827 |
| 6 | 139,676 | 0.475 | 66,369 | 14,274 | 4,790 | 0.411 | 1,968 | 493 |
| 7 | 150,181 | 0.488 | 73,250 | 15,330 | 8,400 | 0.658 | 5,529 | 850 |
| 8 | 74,522 | 0.285 | 21,237 | 7,898 | 553 | 0.187 | 103 | 63 |
| 9 | 1,479,010 | 0.329 | 486,588 | 154,582 | 5,745 | 0.316 | 1,815 | 603 |
| 10 | 1,540,600 | 0.333 | 513,169 | 160,853 | 4,291 | 0.294 | 1,260 | 453 |
| 11 | 125,518 | 0.216 | 27,103 | 13,833 | 6,945 | 0.310 | 2,150 | 730 |
| 12 | 208,469 | 0.326 | 67,857 | 21,808 | 542 | 0.164 | 89 | 63 |

TABLE 5

| | | | | | Properties at 80° C. | | | |
|---|---|---|---|---|---|---|---|---|
| | Properties at 37° C. | | | | | | | Complex |
| | | | | Complex | | | | viscosity |
| | Elastic | | Viscous | viscosity | Elastic | | Viscous | at 10 |
| | Modulus | Tan | Modulus | at 10 rad/s | Modulus | Tan | Modulus | rad/s |
| Sample | (Pa) | Delta | (Pa) | (Pa · s) | (Pa) | Delta | (Pa) | (Pa · s) |
| 1 | 5,912 | 0.653 | 3,863 | 598 | 100 | 0.246 | 25 | 11 |
| 2 | 7,258 | 0.692 | 5,019 | 733 | 75 | 0.216 | 16 | 8 |
| 3 | 6,637 | 1.057 | 7,018 | 667 | 5 | 0.129 | 1 | 1 |
| 4 | 28 | 0.356 | 10 | 3 | 260 | 0.366 | 95 | 27 |
| 5 | 4,313 | 0.763 | 3,293 | 435 | 228 | 0.380 | 87 | 24 |
| 6 | 2,553 | 0.668 | 1,705 | 258 | 223 | 0.335 | 75 | 23 |
| 7 | 5,227 | 0.995 | 5,203 | 525 | 61 | 0.231 | 14 | 7 |
| 8 | 17 | 0.195 | 3 | 2 | 389 | 0.363 | 141 | 40 |
| 9 | 1,384 | 0.532 | 737 | 141 | 125 | 0.237 | 30 | 14 |
| 10 | 1,058 | 0.497 | 525 | 108 | 131 | 0.237 | 31 | 14 |
| 11 | 3,757 | 0.787 | 2,957 | 379 | 17 | 0.187 | 3 | 2 |
| 12 | 49 | 0.364 | 18 | 5 | 263 | 0.396 | 104 | 27 |

Elastic Modulus (G′)

The firmness of the plant-based cheese products is equal to elastic modulus. It is the material's ability to store (as elasticity) part of applied energy during deformation. This energy can be recovered after removal of stress or strain. The elastic modulus is a measure of firmness of the cheese and proportional to the density of intermolecular bonds in the cheese matrix at various temperatures.

The elastic modulus data from 0° C. to 80° C. is also shown in FIG. 1.

It was found that too high of an elastic modulus value increases the brittleness of the cheese product at 5° C. when only 6.67% chickpea protein (about 4% crude protein) was included. Sample 2 was considered unacceptably brittle with an elastic modulus value of 1,465,460 Pa at 5° C.

In contrast, sample 5 with a similar elastic modulus value of 1,313,825 Pa at 5° C. was not too brittle, thus indicating that the higher amount of chickpea protein (about 8% crude protein) in that sample played a role in reducing brittleness in the final product. However, the elastic modulus values for samples 6, 7, and 8 dropped dramatically with the removal of the starches despite the higher amount of chickpea protein.

Similarly, sample 9 had a similar elastic modulus value at 5° C. but was not brittle. Therefore, faba protein behaved differently than chickpea protein at the lower concentration. Despite the lack of brittleness, the faba samples were characterized by a grittier texture and off flavor, which generally made the faba samples less appealing. Also, the elastic modulus values for samples 11 and 12 were significantly lower than sample 9 with the removal of the starches.

At 25° C. and 37° C., samples 4, 8, and 12 were the poorest performing samples. Each of those samples had the lowest elastic modulus values. This indicated that ACCUBIND® (hydrophobic starch) was important to the texture of the plant-based cheese products at the middle temperatures (e.g., 25-37° C.). Samples 4, 8, and 12 also had unacceptably low viscous modulus and complex viscosity values at 25° C. and 37° C.

Further, too low of an elastic modulus value indicates that the samples are soft at those temperatures.

Complex Viscosity

Complex viscosity is a flow property of material under an applied oscillating strain. The material with higher viscosity is relatively less flowable.

At 5° C., 25° C., and 37° C., Samples 4, 8, and 12 had the lowest complex viscosity, which indicated that the lack of ACCUBIND® (hydrophobic starch) resulted in plant-based cheese products that were too soft at 5° C. Samples 7 and 11 without REZISTA® and ShurFIL® (water-managing starch) were also too low at 5° C.

Viscous Modulus (G″)

Viscous modulus is the material's propensity to dissipate energy as heat under deformation. Viscous modulus data is presented in Tables 4 and 5.

At 5° C., Samples 4 and 8 had the lowest complex viscosity, which indicated that the lack of ACCUBIND® (hydrophobic starch) plays a role in the complex viscosity of the plant-based cheese products. Samples 11 and 12 were also quote low compared to the other plant-based cheese products.

At 25° C. and 37° C., Samples 4, 8, and 12 also had the lowest complex viscosity, which indicated that the lack of ACCUBIND® (hydrophobic starch) that the hydrophobic starch was also important for the viscous modulus value at those temperatures.

At 80° C., it is desirable that the viscous modulus value be greater than 20. The data indicated that Sample 2 (no gelling starch) and Samples 3, 7, and 11 (no water-managing starch) had an undesirably low viscous modulus value at 80° C. This means that those plant-based cheese products are too thin at cooking temperature.

Softening

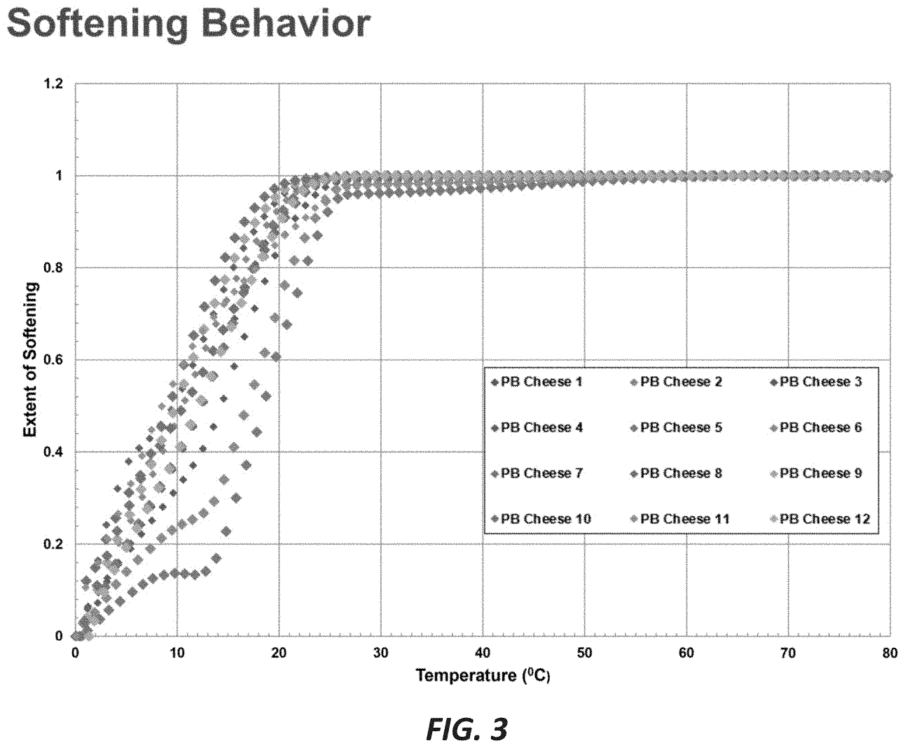

The softening behavior of the samples at 80° C. is summarized in Table 6 below and in FIG. 3. For plant-based cheeses, the temperature at which the material loses 80% of firmness is considered the softening point. At the softening point, the elastic modulus will be equal to 20% of the elastic modulus at 0° C.

TABLE 6

| | Temp at 80% |
|---|---|
| Sample | Softening (° C.) |
| 1 | 18.60 |
| 2 | 15.81 |
| 3 | 16.65 |
| 4 | 14.55 |
| 5 | 17.42 |
| 6 | 20.56 |
| 7 | 21.80 |
| 8 | 17.62 |
| 9 | 14.69 |
| 10 | 13.72 |
| 11 | 17.63 |
| 12 | 17.31 |

The softening behavior data demonstrated that samples 2, 4, 9, and 10 had the lowest temperature at which 80% of the sample had softened. This means that these plant-based cheese samples begin to soften and melt too quickly. Notably, the removal of the starches in samples 2, 3, and 4 all resulted in lower softening temperature than sample 1, while the same trend didn't apply for samples 5-8 (with twice the amount of chickpea), nor for samples 9-12 (the faba protein samples). This likely reflects that the additional maltodextrin in Samples 2-4 softened more abruptly due to its smaller molecular weight, and that the additional chickpea in Samples 6-8 largely negated the impact of removing the starches and replacing them with maltodextrin in terms of the softening behavior of the samples. Samples 9 and 10 with faba protein also softened more quickly than samples 1 and 2 with chickpea protein.

Emulsion Stability

The stability of the emulsions was also evaluated using a Turbiscan (Technex B.V., Netherlands). In the Turbiscan, any physical changes occurring in a sample matrix is tracked by changes in magnitude of light transmission and scattering throughout the length of the sample vial. The changes in transmission increases with increasing separation of oil or water from the matrix. The changes in scattering intensity increases with the coagulation or coalescence in the matrix. The calculated stability index is the cumulative changes in magnitude of the light transmission and scattering, integrated over the length of the tube. A stability index of zero indicates that the sample is stable with no changes in physical status with reference initial state. A more stable matrix will have low stability index when compared to the sample with higher stability index.

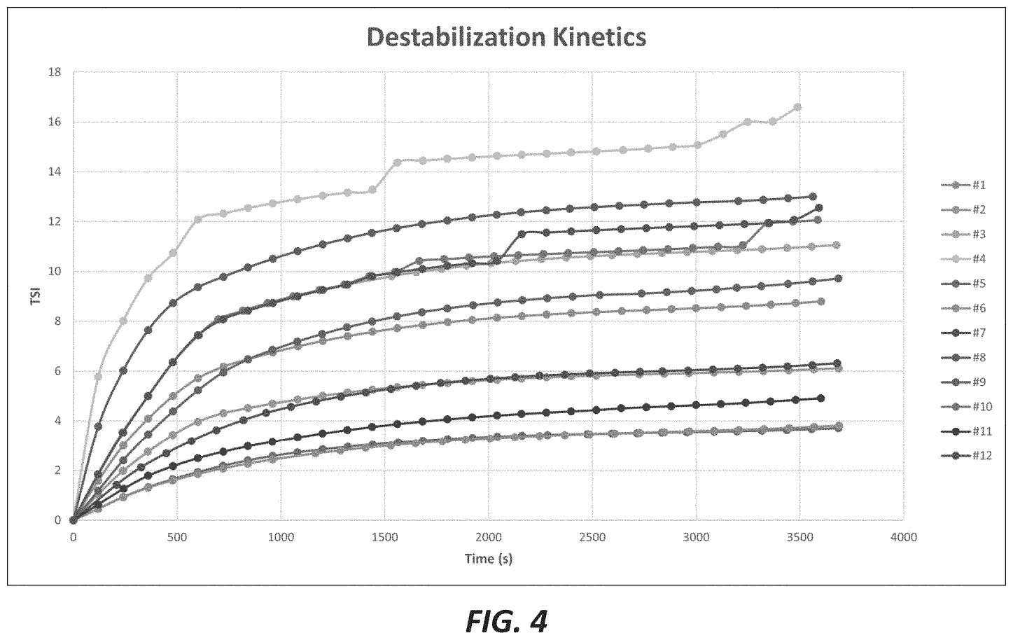

The Turbiscan measurements were carried out at 60° C. and measurement scans were taken at every 2 minutes for 1 hour. The results are presented in FIG. 4 and Table 7. It was found that a TSI of less than 10 indicates a cheese product with desirable melt stability. Higher melt stability (a low stability index value) is most likely due to better fat holding capacity of the protein carbohydrate matrix used in the cheeses. Higher melt stability can be expected for the variables with higher hot viscosity, smaller fat droplets, and better water holding capacities.

TABLE 7

| Sample | TSI Stability Index |
|---|---|
| 1 | 8.80 |
| 2 | 6.11 |
| 3 | 11.1 |
| 4 | 17.0 |
| 5 | 3.71 |
| 6 | 3.81 |
| 7 | 6.31 |
| 8 | 13.1 |
| 9 | 9.72 |
| 10 | 12.1 |
| 11 | 4.92 |
| 12 | 12.6 |

The samples with all three types of starches (samples 1, 5, and 9) had TSI values of less than 10, indicating that those samples had desirable melt stability. Samples 2, 6, 7, and 11 also had acceptable TSI values. However, all samples lacking a hydrophobic starch had unacceptably high TSI values, indicating that the emulsion was unstable and that the oil and water were separating from the matrix at 60° C. Accordingly, it was determined that inclusion of a hydrophobic starch was necessary for desirable melt stability characteristics in the plant-based cheese product.

Fat and Water Droplet Sizes

The samples were further analyzed for fat and water droplet sizes by TD-NMR. In a Bruker TD-NMR droplet size analyzer, the samples were exposed to radio waves in a magnetic field. Upon absorption of the electromagnetic energy, different molecules in the sample resonate at their characteristic frequencies. On removal of the magnetic field, the time decay of the excitation energy is tracked and used in calculating the droplet size distribution. The fat & water droplet size distribution measurements were carried out at 40° C.

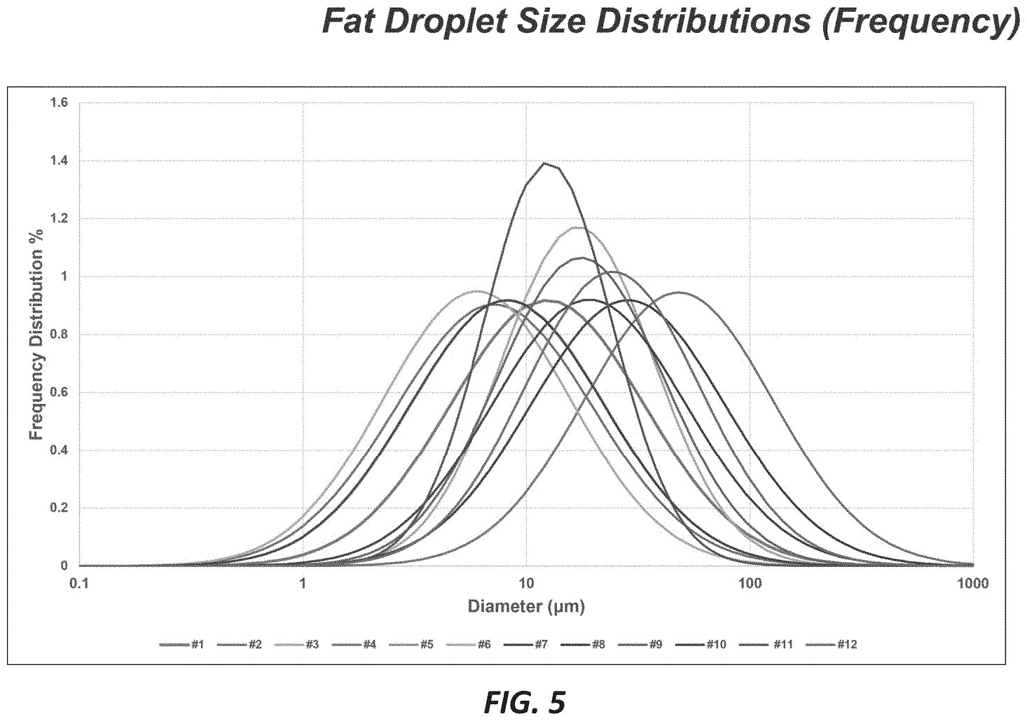

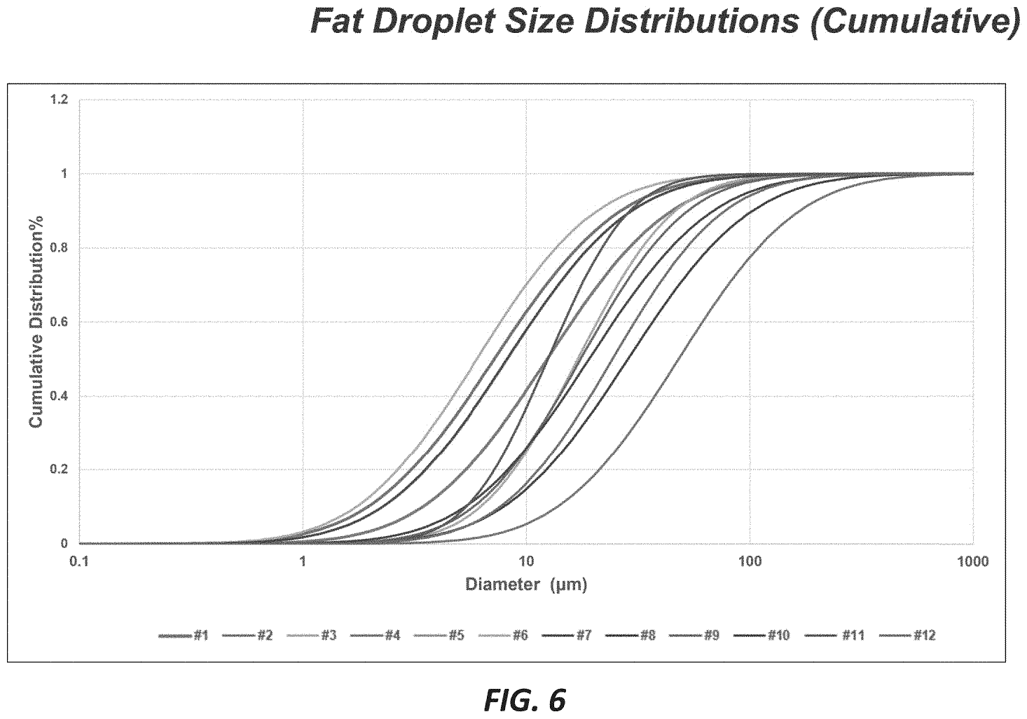

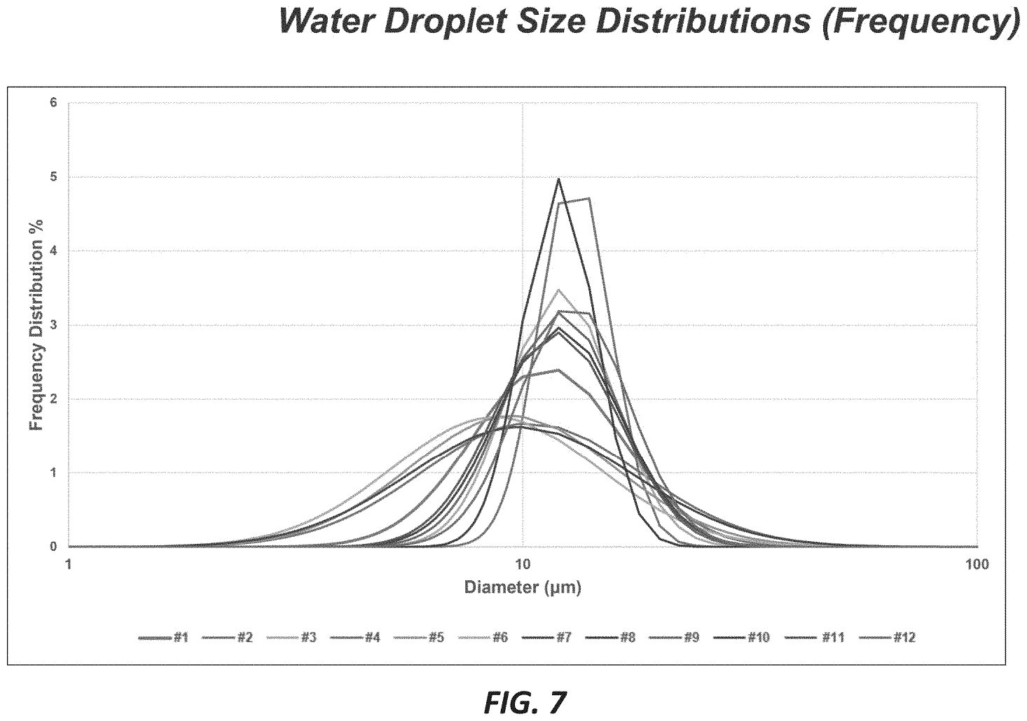

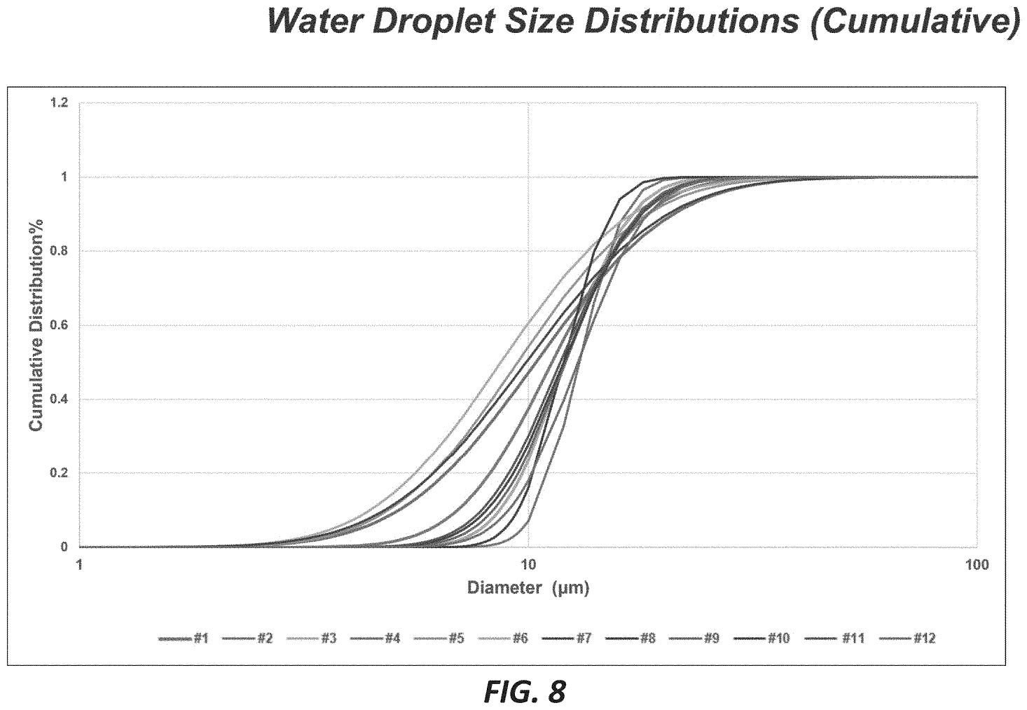

The results are presented in FIG. 5 (fat droplet size distribution—frequency), FIG. 6 (fat droplet size distribution—cumulative), FIG. 7 (water droplet size distribution—frequency), FIG. 8 (water droplet size—cumulative), Table 8 (average fat droplet size distribution) and

Table 9 (average water droplet size distribution). The tests were done in triplicate for each sample. The averages are presented below.

TABLE 8
(Average fat droplet size distribution by NMR at 40° C.)

Diameter (microns)

| | | | | Width of |
|---|---|---|---|---|
| | | | | Distribution |
| Sample | 2_5% | 50% | 97_5% | (st. dev.) |
| 1 | 1.74 | 12.4 | 87.8 | 21.5 |
| 2 | 1.01 | 7.19 | 54.4 | 13.3 |
| 3 | 3.70 | 17.0 | 80.0 | 19.1 |
| 4 | 7.17 | 48.0 | 324 | 79.2 |
| 5 | 1.16 | 8.24 | 58.5 | 14.3 |
| 6 | 0.90 | 6.00 | 40.0 | 9.78 |
| 7 | 1.15 | 8.19 | 58.2 | 14.3 |
| 8 | 4.01 | 28.5 | 202 | 49.5 |
| 9 | 3.25 | 17.5 | 95.4 | 23.0 |
| 10 | 2.70 | 19.1 | 135 | 33.1 |
| 11 | 3.44 | 12.5 | 45.5 | 10.5 |
| 12 | 4.20 | 24.3 | 145 | 35.2 |

Samples 4, 8, and 12, which lacked a hydrophobic starch, had the largest fat droplet sizes due to coalescence. The hydrophobic starches improved the stability of the emulsion during processing. During processing at high shear, in a less stabilized cheese matrix, the fat droplets tend to coalesce if the viscosity of the cheese at the processing condition is not adequate enough to prevent the mobility of fat droplets. These samples confirmed that the combination of the hydrophobic and water-managing starches play a major role in getting the right hot viscosity to keep the emulsion stable during preparation of the cheese products.

TABLE 9
(Average water droplet size distribution by NMR at 40° C.)

Diameter (microns)

| | | | | Width of |
|---|---|---|---|---|
| | | | | Distribution |
| Sample | 2_5% | 50% | 97_5% | (st. dev.) |
| 1 | 5.43 | 11.3 | 24.0 | 4.64 |
| 2 | 3.53 | 10.4 | 30.4 | 6.72 |
| 3 | 7.21 | 12.1 | 20.3 | 3.27 |
| 4 | 9.12 | 13.0 | 18.4 | 2.32 |
| 5 | 3.43 | 9.47 | 26.2 | 5.69 |
| 6 | 3.12 | 8.69 | 24.3 | 5.30 |
| 7 | 3.26 | 9.89 | 30.0 | 6.69 |
| 8 | 8.34 | 12.0 | 17.2 | 2.22 |
| 9 | 6.86 | 12.1 | 21.4 | 3.64 |
| 10 | 6.53 | 12.0 | 22.0 | 3.87 |
| 11 | 6.36 | 11.8 | 22.0 | 3.91 |
| 12 | 7.48 | 12.9 | 22.3 | 3.71 |

Smaller water droplets are expected with cheese matrices containing carbohydrate that has higher water holding capacity at hot processing temperatures. The widening of water droplet size distribution is due to weaker interaction between water droplets and carbohydrates at the processing conditions. The data shows that samples 2 and 7 had the largest water droplet distributions, indicating that lack of the gelling starch resulted in less binding and restricting of the mobility of water droplets during cheese processing.

Sample 6 had finer water droplets and narrower droplet distribution. Because sample 6 lacked the gelling starch, the gelling starch appears to be playing a major role in strongly binding and restricting the mobility of water droplets during cheese processing.

Overall, the present example indicated that samples 1, 5, and 9 with all three starches performed well. The combination of starches plays a major role in providing good hot viscosity to keep the emulsion stable during cheese processing, while also providing desired cold firmness. However, sample 9 was less desirable due to a gritty texture and off flavor from the faba protein.

When the gelling starch was removed (in Samples 2, 6, and 10), Sample 2 had too high of an elastic modulus at 5° C. and was brittle. Sample 2 also softened quickly upon heating. Sample 6 performed well overall but had a much lower elastic modulus than Sample 5 at 5° C., indicating that it will be more difficult to slice at refrigeration temperatures. Sample 10 had a higher TSI stability index value (i.e., low melt stability) value, indicating weak intermolecular interactions.

When the water-managing starches were removed (Samples 3, 7, and 11), the samples had too low of a viscous modulus value at 80° C. (i.e., were too thin at high temperature). Further, Sample 3 had too high of a TSI stability index value, indicating lower melt stability.

When the hydrophobic starch was removed (Samples 4, 8, and 12), the samples had too low of an elastic modulus at 25° C. and 37° C., which indicates that the plant-based cheese products will be more difficult to handle by the consumer. The samples also had a high TSI stability index, indicating poor melt stability. Samples 4, 8, and 12 were further characterized by large fat droplets due to coalescence.

Overall, it was further found that the faba protein was an inferior substitute for chickpea protein in the plant-based cheese products. The plant-based cheeses made with faba protein softened more quickly upon melting of the fat, indicating weaker intermolecular interactions.

### Example 2

An example plant-based cheese product can be prepared according to the formulation of Table 10, which further includes carrageenan. Inclusion of carrageenan provides further flexibility at 5° C. to the plant-based cheese product, which is advantageous for cutting the cheese into slices. The method as described in Example 1 can be followed. The carrageenan can be added with the starches.

TABLE 10

| | Sample 1 | Sample 2 |
|---|---|---|
| Coconut oil | 24.25% | 23.77% |
| ACCUBIND ® | 9.00% | 9.00% |
| 12675 | | |
| Water | 43.909% | 44.460% |
| Lactic acid | 0.10% | 0.10% |
| Artesa | 6.67% | 13.33% |
| Chickpea | | |
| Protein (60% | | |
| crude protein) | | |
| STAR-DRI ® | 6.22% | 3.35% |
| 100 maltodextrin | | |
| (Tate & Lyle) | | |
| THINGUM ® | 1.00% | 1.00% |
| 107A starch | | |
| ShurFIL ® 677 | 3.70% | 0.84% |
| starch | | |
| REZISTA ® | 3.00% | 2.00% |
| starch | | |
| Carrageenan | 0.2% | 0.2 |
| Sodium | 1.77% | 1.77% |
| chloride (salt) | | |
| Sorbic acid | 0.18% | 0.18% |
| Total | 100.000% | 100.000% |
| Crude protein % | 4.00% | 8.00% |
| (calculated) | | |

### Example 3

Seven examples of the plant-based cheese products disclosed herein were prepared. Each of the example plant-based cheese products included chickpea protein as the plant-based protein, and coconut oil as the oil.

Each of the example plant-based cheese products were prepared by first melting coconut oil in a cooker. Water was added to the melted coconut oil, and then lactic acid was added in an amount effective to provide a pH within the range of about 4.8 to about 5.0 in the final product. Chickpea protein, maltodextrin, salt, sorbic acid, colorant, flavors, REZISTA® starch (Tate & Lyle), and ACCUBIND® starch (Cargill) were added, and the ingredients were then mixed and heated (via steam injection) in a steam injection cooker (Stephan Machinery GmbH) at shear rate and for a time period sufficient to produce a homogenous mixture. Once the mixture was well mixed, it was further heated (via steam injection) to 185° F. and held at 185° F. for 1 minute. Then, the heated mixture was filled into a box and allowed to cool to form a block of the plant-based cheese product.

The general formulation of each plant-based cheese product is shown in Table 11, with the wt % of each ingredient that was used (based on the total weight of the plant-based cheese product). In Table 11, the plant-based cheese products are referred to as “PBCA 1,” “PBCA 2,” “PBCA 3,” “PBCA 4,” “PBCA 5,” “PBCA 6,” and “PBCA 7.”

TABLE 11

| | PBCA 1 | PBCA 2 | PBCA 3 | PBCA 4 | PBCA 5 | PBCA 6 | PBCA 7 |
|---|---|---|---|---|---|---|---|
| Ingredient | (wt %) | (wt %) | (wt %) | (wt %) | (wt %) | (wt %) | (wt % |
| Colorant | 0.07 | 0.07 | 0.07 | 0.07 | 0.07 | 0.06 | 0.06 |
| Salt | 1.70 | 1.70 | 1.70 | 1.70 | 1.70 | 1.70 | 1.70 |
| Sorbic Acid | 0.18 | 0.18 | 0.18 | 0.18 | 0.18 | 0.18 | 0.18 |
| REZISTA ® | 2.00 | 2.00 | 2.00 | 2.00 | 2.00 | 2.00 | 2.00 |
| Starch | | | | | | | |
| (Modified | | | | | | | |
| Waxy) | | | | | | | |
| ACCUBIND ® | 9.00 | 9.00 | 9.00 | 9.00 | 9.00 | 9.00 | 9.00 |
| Starch | | | | | | | |
| (Hydrophobic) | | | | | | | |
| Flavors | 2.53 | 2.55 | 1.43 | 1.43 | 1.48 | 2.53 | 2.55 |
| ARTESA ® | 13.33 | 13.33 | 13.33 | 13.33 | 13.33 | 6.67 | 6.67 |
| Chickpea | | | | | | | |
| Protein | | | | | | | |
| STAR-DRI ® | 2.57 | 2.55 | 3.74 | 3.74 | 3.69 | 9.51 | 9.49 |
| 10 | | | | | | | |
| Maltodextrin | | | | | | | |
| Coconut Oil | 24.09 | 24.09 | 24.10 | 24.10 | 24.10 | 24.24 | 24.24 |
| Water | 35.43 | 35.43 | 35.35 | 35.35 | 35.35 | 35.01 | 35.01 |
| Lactic Acid | 0.10 | 0.10 | 0.10 | 0.10 | 0.10 | 0.10 | 0.10 |
| (88%) | | | | | | | |
| Condensate | 9.00 | 9.00 | 9.00 | 9.00 | 9.00 | 9.00 | 9.00 |
| Total | 100.00 | 100.00 | 100.00 | 100.00 | 100.00 | 100.00 | 100.00 |
| Water % | 46.50% | 46.50% | 46.50% | 46.50% | 46.50% | 46.50% | 46.50% |
| Fat % | 24.40% | 24.40% | 24.40% | 24.40% | 24.40% | 24.40% | 24.40% |
| Crude | 8.00% | 8.00% | 8.00% | 8.00% | 8.00% | 4.00% | 4.00% |
| protein % | | | | | | | |
| (calculated) | | | | | | | |
| Total salt % | 1.70% | 1.70% | 1.70% | 1.70% | 1.70% | 1.70% | 1.70% |

Each of the example plant-based cheese products had an appearance, taste, cold texture, and hot/melt texture consistent with consumer expectations for a dairy-based cheese product.

Further, for each of PBCA 1 and PBCA 6 a slice of the plant-based cheese product was placed between two slices of bread and grilled to produce a grilled cheese type product.

The slice of each of PBCA 1 and PBCA 6 melted. The grilled cheese type product with PBCA 1 melted therein is shown in FIG. 1. The grilled cheese type product with PBCA 6 melted therein is shown in FIG. 2.

### Example 4

Six additional examples of the plant-based cheese products disclosed herein were prepared. Each of the additional examples of the plant-based cheese products had the same general formulation as PBCA 1 (shown in Table 12), except that the additional examples did not include colorant or flavors and included additional maltodextrin to replace the lack of colorant and flavors.

Each of the additional plant-based cheese products were prepared by first melting the coconut oil. Then, water was added to the melted coconut oil. Then, the lactic acid was added to produce a pH within the range of about 4.8 to about 5.0 in the final product. Then, the chickpea protein, maltodextrin, salt, sorbic acid, REZISTA® starch (water managing starch from Tate & Lyle), and ACCUBIND® starch (hydrophobic starch from Cargill) were added. The ingredients were then mixed and heated (via steam injection) in a steam injection cooker (Stephan Machinery GmbH) at the mixing speed (shown in Table 12) for the mixing time period (shown in Table 2). Once the mixture was mixed, it was heated (via steam injection) to 185° F. and held at 185° F. for 1 minute. Then, the heated mixture was filled into a box and allowed to cool to form a block of the example plant-based cheese product.

The mixing speed and the mixing time period for each of the additional example plant-based cheese products are shown in Table 12. In Table 12, the additional example plant-based cheese products are referred to as “PBCA 8,” “PBCA 9,” “PBCA 10,” “PBCA 11,” “PBCA 12,” and “PBCA 13.”

TABLE 12

| | Mixing | Mixing Time |
|---|---|---|
| Plant-Based Cheese | Speed | Period |
| Alternative | (rpm) | (minutes) |
| PBCA 8 | 1200 | 4 |
| PBCA 9 | 2500 | 4 |
| PBCA 10 | 1200 | 10 |
| PBCA 11 | 2500 | 10 |
| PBCA 12 | 500 | 4 |
| PBCA 13 | 500 | 10 |

Each of the additional example plant-based cheese products had an appearance, taste, cold texture, and hot/melt texture consistent with consumer expectations for a dairy-based cheese.

### Example 5

An additional example of the plant-based cheese product disclosed herein was prepared. The additional example of the plant-based cheese product had the same general formulation as PBCA 1 (shown in Table 10), except that the additional example did not include colorant and included additional maltodextrin to replace the lack of colorant.

The additional example plant-based cheese product was prepared by first melting the coconut oil. Then, the REZISTA® starch (water-managing starch) and ACCUBIND® starch (hydrophobic starch) were added, and the combination of the melted coconut oil, the REZISTA® starch, and the ACCUBIND® starch was thoroughly mixed to provide a homogeneous mixture of the starches in the melted coconut oil. Water and lactic acid were added. Lactic acid was added in an amount effective to provide a pH within the range of about 4.8 to about 5.0 in the final product. The chickpea protein, maltodextrin, salt, and sorbic acid were then added. The ingredients were mixed and heated (via steam injection) in a steam injection cooker (Stephan Machinery GmbH) at 2500 rpm for 10 minutes. Flavors were added, and the mixture was heated (via steam injection) to 185° F. and held at 185° F. for 1 minute. The heated mixture was filled into a box and allowed to cool to form an about 20 lb to about 24 lb block of the example plant-based cheese product.

The additional example plant-based cheese product had an appearance, taste, cold texture, and hot/melt texture consistent with consumer expectations for a dairy-based cheese.

### Example 6

A further example of the plant-based cheese product disclosed herein can be prepared. The additional example of the plant-based cheese product has the same general formulation as PBCA 1 (shown in Table 10), except that the additional example did not include colorant or flavors and included additional maltodextrin to replace the lack of colorant or flavors.

The additional example plant-based cheese product is prepared by first melting the coconut oil. Water and lactic acid are added. Lactic acid is added in an amount effective to provide a pH within the range of about 4.8 to about 5.0 in the final product. The chickpea protein, maltodextrin, salt, and sorbic acid are then added. The ingredients are mixed and heated (via steam injection) in a steam injection cooker (Stephan Machinery GmbH) at shear rate and for a time period sufficient to produce a homogenous mixture. The mixture is then heated (via steam injection) to 185° F. Then, the REZISTA® starch and ACCUBIND® starch are added to water and thoroughly mixed to provide a homogeneous mixture. The starches and water mixture are added to the mixture in a steam injection cooker, and then the mixture is held at 185° F. for 1 minute. The heated mixture is filled into a box and allowed to cool to form a block of the example plant-based cheese product having an appearance, taste, cold texture, and hot/melt texture consistent with consumer expectations for a dairy-based cheese.

It is to be understood that the ranges provided herein include the stated range and any value or sub-range within the stated range. For example, a range of about 5 wt % to about 15 wt % should be interpreted to include not only the explicitly recited limits of range of about 5 wt % to about 15 wt %, but also to include individual values, such as 6.35 wt %, 7.5 wt %, 10 wt %, 12.75 wt %, 14 wt %, etc., and sub-ranges, such as about 7 wt % to about 10.5 wt %, about 8.5 wt % to about 12.7 wt %, about 9.75 wt % to about 14 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A plant-based cheese product comprising:
2 wt % to less than 6 wt % plant-based crude protein;
about 7 wt % to about 13 wt % hydrophobic starch;
about 4 wt % to about 12 wt % water-managing starch; and
about 0.25 wt % to about 4 wt % gelling starch,
a fat component having a solid fat content in the range of 30% to about 60% at 50° F. and 0% to about 10% at 92° F.; and
an acidulant in an amount effective to provide a pH of the plant-based cheese product of about 4.5 to about 5.7.

2. The plant-based cheese product as defined in claim 1, wherein the plant-based crude protein is chickpea protein, fava protein, soy protein, mung bean protein, pea protein, canola protein, lentil protein or a combination thereof.

3. The plant-based cheese product as defined in claim 1, wherein the plant-based crude protein is chickpea protein.

4. The plant-based cheese product as defined in claim 1, wherein the plant-based crude protein is present in an amount within the range of about 2.5 wt % to about 5.5 wt % crude protein, based on a total weight of the plant-based cheese product.

5. The plant-based cheese product as defined in claim 1, wherein the plant-based crude protein is present in an amount within the range of about 3 wt % to about 5 wt % crude protein, based on a total weight of the plant-based cheese product.

6. The plant-based cheese product as defined in claim 1, wherein the hydrophobic starch is present in an amount within the range of about 8 wt % to about 11 wt %, based on a total weight of the plant-based cheese product.

7. The plant-based cheese product as defined in claim 1, wherein the hydrophobic starch is present in an amount within the range of about 8 wt % to about 10 wt %, based on a total weight of the plant-based cheese product.

8. The plant-based cheese product as defined in claim 1, wherein the water-managing starch is present in the range of about 4 wt % to about 10 wt %, based on a total weight of the plant-based cheese product.

9. The plant-based cheese product as defined in claim 1, wherein the water-managing starch is present in the range of about 5 wt % to about 9 wt %, based on a total weight of the plant-based cheese product.

10. The plant-based cheese product as defined in claim 1, wherein the gelling starch is present in the range of about 0.5 wt % to about 3 wt %, based on a total weight of the plant-based cheese product.

11. The plant-based cheese product as defined in claim 1, wherein the fat component is present in an amount within the range of about 15 wt % to about 30 wt %, based on a total weight of the plant-based cheese product.

12. The plant-based cheese product as defined in claim 1, further comprising a flexibility enhancing agent in the range of about 0.05 wt % to about 5 wt %, based on a total weight of the plant-based cheese product, wherein the flexibility enhancing agent is selected from one or more of instant starch, xanthan gum, guar gum, locust bean gum, cellulose gum, fenugreek gum, konjac gum, agar, gellan gum, propylene glycol alginate, alginate, microcrystalline cellulose, carboxymethyl cellulose, konjac glucomannan, carrageenan, and pectin.

13. The plant-based cheese product as defined in claim 1, wherein the plant-based cheese product is in the form of a cheese block, a diced cheese, or a shredded cheese.

14. A plant-based cheese product comprising:
6 wt % to 10 wt % plant-based crude protein;
about 7 wt % to about 13 wt % hydrophobic starch;
about 1 wt % to about 8 wt % water-managing starch; and
about 0.25 wt % to about 4 wt % gelling starch,
a fat component having a solid fat content in the range of 30% to about 60% at 50° F. and 0% to about 10% at 92° F.; and
an acidulant in an amount effective to provide a pH of the plant-based cheese product of about 4.5 to about 5.7.

15. The plant-based cheese product as defined in claim 14, wherein the plant-based crude protein is chickpea protein, fava protein, soy protein, mung bean protein, pea protein, canola protein, lentil protein, or a combination thereof.

16. The plant-based cheese product as defined in claim 14, wherein the plant-based crude protein is chickpea protein.

17. The plant-based cheese product as defined in claim 14, wherein the plant-based crude protein is present in an amount within the range of about 6.5 wt % to about 9.5 wt % crude protein, based on a total weight of the plant-based cheese product.

18. The plant-based cheese product as defined in claim 14, wherein the plant-based crude protein is present in an amount within the range of about 7 wt % to about 7 wt % crude protein, based on a total weight of the plant-based cheese product.

19. The plant-based cheese product as defined in claim 14, wherein the plant-based cheese product is in the form of a cheese block, a diced cheese, or a shredded cheese.

20. The plant-based cheese product as defined in claim 14, further comprising a flexibility enhancing agent in the range of about 0.05 wt % to about 5 wt %, based on a total weight of the plant-based cheese product, wherein the flexibility enhancing agent is selected from one or more of instant starch, xanthan gum, guar gum, locust bean gum, cellulose gum, fenugreek gum, konjac gum, agar, gellan gum, propylene glycol alginate, alginate, microcrystalline cellulose, carboxymethyl cellulose, konjac glucomannan, carrageenan, and pectin.
